(19) United States
(12) Patent Application Publication
(10) Pub. No.: US 2004/0225868 A1
(43) Pub. Date: Nov. 11, 2004

(54) AN INTEGRATED CIRCUIT HAVING PARALLEL EXECUTION UNITS WITH DIFFERING EXECUTION LATENCIES

(75) Inventors: Suhwan Kim, Nanuet, NY (US); Stephen V. Kosonocky, Wilton, CT (US); Peter A. Sandon, Essex Junction, VT (US)

Correspondence Address: IBM MICROELECTRONICS, INTELLECTUAL PROPERTY LAW, 1000 RIVER STREET, 972 E, ESSEX JUNCTION, VT, 05452, US

(73) Assignee: International Business Machines Corporation, Armonk, NY

(21) Appl. No.: 10/249,778

(22) Filed: May 7, 2003

(51) Int. Cl. G06F 9/30

(52) U.S. Cl. 712/214

(57) ABSTRACT

An integrated circuit having a plurality of execution units each of which has a corresponding parallel execution unit. Each one of the parallel execution units has substantially the same functionality as its corresponding execution unit. Each parallel execution unit has greater latency but uses less power than its corresponding execution unit.

### BACKGROUND OF INVENTION

1. Technical Field of the Present Invention

The present invention generally relates to integrated circuits, and more specifically, to integrated circuits having multiple parallel execution units each having differing execution latencies.

2. Description of Related Art

Consumers have driven the electronic industry on a continuous path of increasing functionality and speed in devices, while steadily reducing the physical size of the devices themselves. This drive towards smaller faster devices has challenged the industry in several different areas. One particular area has been reducing the power demands for these devices so that they can operate longer on a given portable power source. Current solutions have used alternating clock speeds, voltage stepping and the like. Although these solutions have been helpful in increasing battery life, they often result in an overall performance reduction.

It would, therefore, be a distinct advantage to have an integrated circuit that could increase the battery life without sacrificing performance. The present invention provides such an integrated circuit.

### SUMMARY OF INVENTION

In one aspect, the present invention is an integrated circuit having a plurality of execution units. Within the integrated circuit, a corresponding parallel execution unit exists for each one of the execution units. Each parallel execution unit has substantially the same functionality as its corresponding execution unit, and a latency that is greater than that of its corresponding execution unit. The design of the parallel execution unit provides it with the capability of using less power than its corresponding execution unit when executing the same task.

### BRIEF DESCRIPTION OF DRAWINGS

The present invention will be better understood and its numerous objects and advantages will become more apparent to those skilled in the art by reference to the following drawings, in conjunction with the accompanying specification, in which:

FIG. 1 is a high level block diagram illustrating a computer data processing system in which the present invention can be practiced;

FIG. 2 is a block diagram illustrating in greater detail the internal components of the processor core of the computer data processing system of FIG. 1 according to the teachings of the present invention;

FIG. 3 is a block diagram illustrating one of the internal components (Execution units) of FIG. 2 and its corresponding parallel execution unit in a fixed point multiply embodiment according to the teachings of the present invention;

FIG. 4 is a flow chart illustrating a preferred method for optimizing code intended to execute on a superscalar architecture according to the teachings of the present invention; and

FIG. 5 is a block diagram illustrating additional circuitry that can be included in the processor core 110 according to an alternative embodiment of the present invention.

### DETAILED DESCRIPTION

In the following description, well-known circuits have been shown in block diagram form in order not to obscure the present invention in unnecessary detail. For the most part, details concerning timing considerations and the like have been omitted inasmuch as such details are not necessary to obtain a complete understanding of the present invention, and are within the skills of persons of ordinary skill in the relevant art.

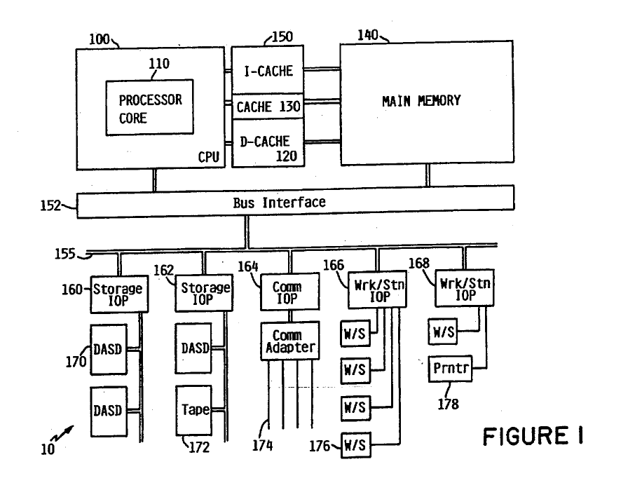

The present invention provides the ability to reduce power consumption by providing additional low power execution units within an integrated circuit. More specifically, the additional units parallel all or some of the existing execution units within the integrated circuit. The combined parallel execution units have one unit for performance based executions and the other unit for power saving based executions. The present invention is explained as residing within a particular data processing system 10 as illustrated and discussed in connection with FIG. 1 below.

Reference now being made to FIG. 1, a high level block diagram is shown illustrating a computer data processing system 10 in which the present invention can be practiced. Central Processing Unit (CPU) 100 processes instructions and is coupled to D-Cache 120, Cache 130, and I-Cache 150. Instruction Cache (I-Cache) 150 stores instructions for execution by CPU 100. Data Cache (D-Cache) 120 and Cache 130 store data to be used by CPU 100. The caches 120, 130, and 150 communicate with random access memory in main memory 140.

CPU 100 and main memory 140 also communicate with system bus 155 via bus interface 152. Various input/output processors (IOPs) 160-168 attach to system bus 155 and support communication with a variety of storage and input/output (I/O) devices, such as direct access storage devices (DASD) 170, tape drives 172, remote communication lines 174, workstations 176, and printers 178.

It should be understood that the data processing system 10 illustrated in FIG. 1 is a high level description of a typical computer system and various components have been omitted for purposes of clarification. Furthermore, data processing system 10 is intended only to represent an example of a computer system in which the present invention can be practiced, and is not intended to restrict the present invention from being practiced on any particular make or type of computer system.

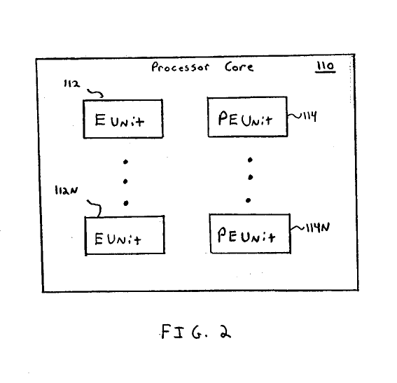

FIG. 2 is a block diagram illustrating in greater detail the internal components of the processor core 110 of FIG. 1 according to the teachings of the present invention. Specifically, processor core 110 includes a plurality of execution units (EUnits) 112-112N which can be, for example, a multiplier. In general, each of the EUnits 112-112N are constructed so as to have optimal performance. For each one of the EUnits 112-112N, there exists a corresponding identical PEUnit 114-144N that can perform the same function as its corresponding EUnit 112-112N, but with increased latency and less power.

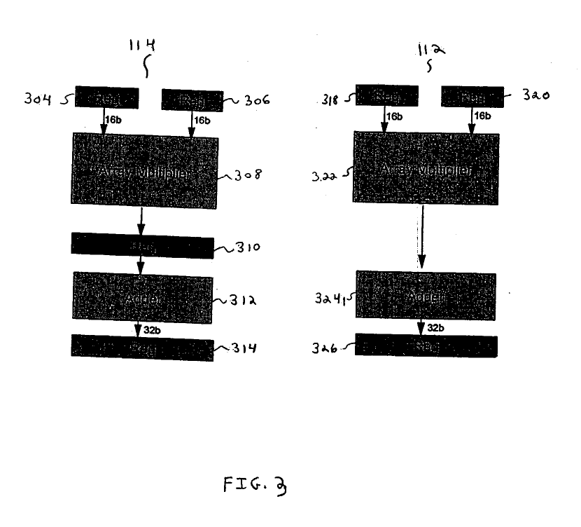

In order to clarify and enumerate the various benefits provided by the present invention, an example of a preferred embodiment is described hereinafter. In this embodiment, the examples will relate to execution units responsible for ultra-fast instruction sequences or multiple sets of data. In these particular examples, the performance for long iterative loops, containing for example, many fixed point multiply instructions, is based on the latency per cycle (the depth of the pipeline is not critical). Continuing with the example, in certain circumstances the fixed point multiply could be accomplished in two cycles in order to reduce power consumption while still meeting required performance objectives as explained in connection with the description of FIG. 3 below.

Reference now being made to FIG. 3, a block diagram is shown illustrating one of the Execution units 112 of FIG. 2 and its corresponding parallel execution unit 114 in a fixed point multiply embodiment according to the teachings of the present invention. In this example, execution unit (multiplier) 112 is a high performance single stage multiplier having three registers 318, 320, and 326, an adder 324, and an array multiplier 322. The corresponding parallel execution unit (multiplier) 114 is a two-stage multiplier having four registers 304, 306, 310, and 314, an adder 312, and an array multiplier 308.

Multiplier 112 is constructed for performance while multiplier 114 is constructed for reducing power consumption. For example, in a particular embodiment, multipliers 112 and 114 can reside within a processor running at a maximum frequency of 250 MHz, multiplier 112 being powered by 1.5 volts, and multiplier 114 being powered by 0.9 volts. Multiplier 114 operates at a 3.66 nanosecond delay (Max{td(array 308)+td(reg 310), td(adder 312)+td(reg 314)), with a total power consumption of 1.17 milliwatts at 0.9 volts. Multiplier 112 operates at a 2.84 nanosecond delay (Max{td(array 322)+td(adder 324)+td(reg 326)), with a total power consumption of 3.6 milliwatts at 1.5 volts.

The architecture of the present invention provides the compiler with the option of selecting a base instruction for execution by the execution unit 112 or the corresponding parallel execution unit 114, depending upon the particular latency required for the instruction (e.g. <3.66 ns=112, >=3.66 ns=114).

In the preferred embodiment of the present invention, two versions of a fixed point multiply instruction Mul and Mul_lp are provided to the compiler for selection of either multiplier 112 or 114, respectively.

In general, the compiler can be broken into front end and back end processes. The front end process of the compiler parses and translates the source code into intermediate code. The back end process of the compiler optimizes the intermediate code, and generates executable code for the specific processor architecture. As part of the back end process, a Directed Acyclic Graph (DAG) is generated to represent the computations and movement of data within a basic block. The optimizer/compiler uses the DAG to generate and schedule the executable code so as to optimize some objective function. In this example, it is assumed that the optimizer is optimizing for performance.

Using the present example, the optimizer attempts to execute the functionality described in the DAG in a minimum number of cycles. In the case of multiple cycle instructions, the DAG nodes are labeled with latency values, and in the case of superscaler, the optimizer fills multiply parallel pipes with instruction sequences.

In the present embodiment, it is further advantageous for purposes of clarity to explain the processor core 100 as executing within two types of processor architectures (Digital Signal Processor (DSP) and general purpose superscaler).

For the DSP processor architecture, it is typical to execute relatively long streams of multiply (or multiply-accumulate) instructions in sequence. These instructions may be in successive iterations of a loop, which, due to zero delay branching, have the characteristics of a single, long basic block. In this case, using longer latency instructions (e.g. Mul_lp ) increases the overall execution time of the calculation, but only by the additional latency of one instruction (due to pipelining). Thus, it can be seen that the added execution time is only significant when the overall execution time is small, as would be the case for short loops. The compiler can decide whether to use the low latency version of the instruction (e.g. Mul) based on the value of the initial loop counter (often a constant), and the execution time of an iteration of the loop compared to the latency difference of the two alternative instructions.

For the superscaler processor architecture, optimization across loop iterations is often more difficult, though loop unrolling can obviate this, and so optimization is performed with the basic block itself. First, the compiler builds a DAG in which all multiply nodes are labeled with the latency associated with the high performance low latency execution unit (e.g. Multiplier 112). The optimized code generated from this DAG yields the minimum time (Maximum performance) sequence for this basic block. The task now is to replace as many Mul instructions with Mul_lp instructions such that the execution time is not significantly increased.

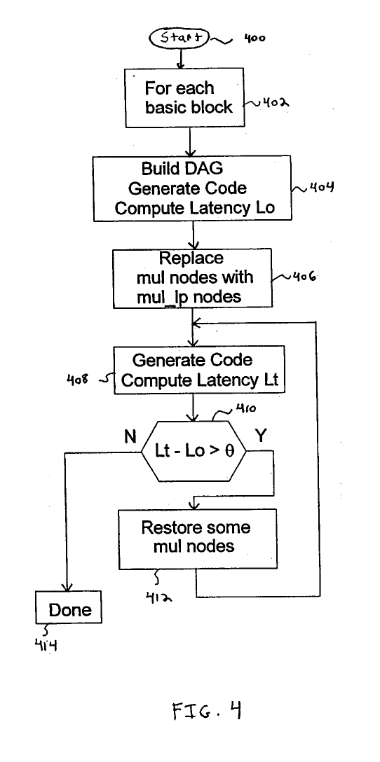

The task can be accomplished in numerous ways, however, it is most desirable to use the method that requires the least computational resources. For example, the DAG and instruction schedule can be examined to identify each Mul instruction whose result is not required in the cycle that it becomes available. Further analysis can identify additional sequences where dependencies allow delays in dispatch that can be propagated to the Mul instruction. A preferred embodiment for a superscalar architecture is explained in connection with FIG. 4.

Reference now being made to FIG. 4, a flow chart is shown illustrating a preferred method for optimizing code intended to execute on a superscalar architecture according to the teachings of the present invention. Specifically, the method begins at step 400 where each basic block (step 402) is used by the compiler to build a DAG in which all multiply nodes are labeled with the latency associated with the low latency execution multiplier 112 (Mul). Thereafter, all Mul instructions are replaced with Mul_lp instructions (i.e. Targeted for execution on the two stage multiplier 114) (step 406). The code is then optimized using the Mul_lp instructions with the multiply nodes labeled with the corresponding latency (step 408). If the total new latency is less than a predetermined threshold, then the method is complete and ends (steps 410 and 414). If, however, the total new latency is greater than or equal to the predetermined threshold, then some of the Mul_lp instructions are replaced with Mul instructions (step 412), and the code is optimized as previously stated at step 408.

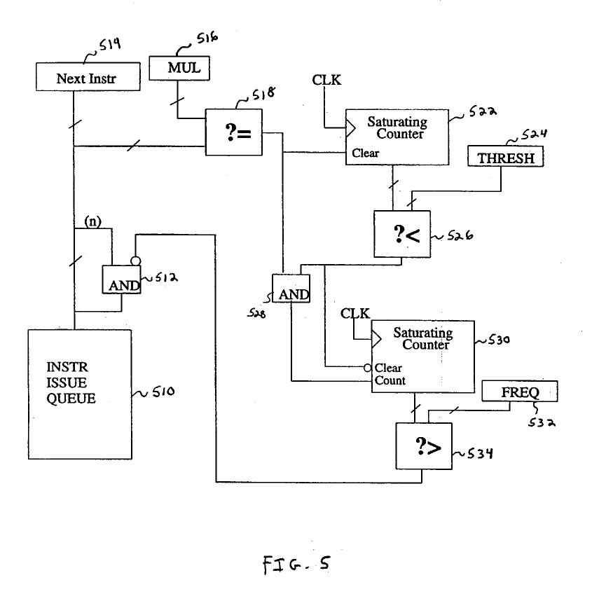

For some applications which run with existing compiled program code or use an existing software compiler, it is desirable to dynamically (during program run-time) convert a high power, low latency instruction to a lower power, higher latency instruction when the program is detected to be running within a long inner loop of an algorithm. One method of detecting a signature of a long inner loop, is to measure the minimum distance between identical instructions and the number of occurrences of those instructions. An alternative embodiment of the present invention supports these types of applications by having the processor core 110 perform the dynamic conversion as explained in connection with FIG. 5.

Reference now being made to FIG. 5, a block diagram is shown illustrating additional circuitry that can be included in the processor core 110 according to an alternative embodiment of the present invention.

The additional circuitry scans the stream of instructions for a certain number of occurrences (as specified by the value stored in the Thresh register 524) of target instructions (e.g. Mul) within a specified distance. If these occurrences fall within the specified distance, then the Mu/instruction is converted to a lower power, higher latency instruction such as the Mul_lp as explained below.

In this particular embodiment, the Mul and Mul_lp instructions differ by a single bit value (n). The required distance between consecutive Mu/instructions in terms of cycle counts is given by l(dist) which is equal to the value stored in the Thresh register 524.

The additional circuitry includes a Next instruction register 514 for storing the last instruction fetched from the Instruction Cache 150. The target instruction register 516 stores the target instruction to be examined. In this particular example, the target instruction is the Mul instruction. If the last instruction matches the target instruction, then Compare-equal circuit 518 outputs an indication of a positive comparison. The result of the positive comparison is fed into a first Saturating Counter 522.

The first Saturating Counter 522 counts up each cycle of the clock (clk) until the clear input receives such a positive indication. The value of the first Saturating Counter 522 is compared to the value stored in the Thresh register 524.

If the value of the first Saturating Counter 522 is less than the value stored in the Thresh register 524, then the Compare-less-than circuit 526 provides a positive indication to AND circuit 528. If a subsequent Mul instruction is received while Compare-less-than circuit 526 is providing the positive indication to AND circuit 528, then a second Saturating Counter 530 is incremented. If the output of the second Saturating Counter 530 exceeds a value stored in the Freq register 532, then the output of a Compare-greater-than circuit 534 is positive which ANDs this value with the Mul instruction to create the Mul_lp instruction (assuming in this case that only 1 bit distinguishes one instruction from the other). The newly created Mul_lp instruction is then stored in the Instruction Issue Queue 510.

If the distance between the next subsequent Mul instruction exceeds the difference between the value stored in the Thresh register 524, then the Compare-less-than circuit 526 outputs a low value which clears the second saturating counter 530, and the subsequent Mul instruction continues to be stored in the Instruction Issue Queue 510 unmodified.

Likewise, someone skilled in the art can see that it may also be beneficial to design a system such that all standard multiply instructions are considered low power long latency (i.e. Mul_lp) and dynamically switch to low latency high power instruction (i.e. Mul) when a use dependency exists.

It is thus believed that the operation and construction of the present invention will be apparent from the foregoing description. While the method and system shown and described has been characterized as being preferred, it will be readily apparent that various changes and/or modifications could be made without departing from the spirit and scope of the present invention as defined in the following claims.

1. An integrated circuit comprising:
a plurality of execution units; and
a plurality of parallel execution units each one corresponding to one of the execution units and having substantially the same functionality as its corresponding execution unit, each one of the parallel execution units having a latency that is greater than that of its corresponding execution unit.

2. The integrated circuit of claim 1 wherein the latency is measured by the number of clock cycles required to complete a given operation.

3. The integrated circuit of claim 2 wherein the execution and parallel execution units are multiply units.

4. The integrated circuit of claim 1 wherein each one of the parallel execution units consumes less power than its corresponding execution unit.

5. The integrated circuit of claim 4 further comprising:
a scheduling circuit for receiving instructions for execution and for providing the received instructions to one of the execution units or its corresponding parallel execution unit depending upon the latency requirements of the received instructions.

6. The integrated circuit of claim 5 wherein the instructions themselves indicate one of the execution units or corresponding parallel execution units for execution thereof.

7. A microprocessor comprising:
a first execution unit; and
a second execution unit having substantially the same functionality as the first execution unit, and having a latency that is longer than that of the first execution unit.

8. The microprocessor of claim 7 wherein the second execution unit consumes less power than the first execution unit.

9. The microprocessor of claim 8 wherein latency is measured in clock cycles.

10. The microprocessor of claim 8 wherein the first and second execution units are multipliers.

11. The microprocessor of claim 10 wherein the first execution unit is a single stage multiplier, and the second execution unit is a two stage multiplier.

12. The microprocessor of claim 11 wherein the first execution unit operates at a higher voltage than the second execution unit.

13. A computer system comprising:
memory for storing data;
a bus for communicating with the memory; and
a microprocessor, coupled to the bus, for executing instructions, the microprocessor having a first execution unit and a second execution unit, the second execution unit having substantially the same functionality as the first execution unit, and a latency that is greater than that of the first execution unit.

14. The computer system of claim 13 wherein the second execution unit consumes less power than the first execution unit.

15. The computer system of claim 14 wherein latency is measured in clock cycles.

16. The computer system of claim 14 wherein the first and second execution units are multipliers.

17. The computer system of claim 16 wherein the first execution unit is a single stage multiplier and the second execution unit is a two stage multiplier.

18. The computer system of claim 17 wherein the second execution unit operates at lower voltage than that of the first execution unit.
